(19) United States
(12) Patent Application Publication
(10) Pub. No.: US 2006/0285673 A1
(43) Pub. Date: Dec. 21, 2006

(54) Unbundled call control over the public switched telephone network

(75) Inventors: Nicholas Michael DeVito, Naperville, IL (US); Eric Edward Kampmeier, Sycamore, IL (US); Thomas J. Loos, Ann Arbor, MI (US); Simon S. Ou, Naperville, IL (US)

Correspondence Address: Werner Ulrich, 434 Maple Street, Glen Ellyn, IL, 60137, US

(73) Assignee: Lucent Technologies, Inc.

(21) Appl. No.: 11/141,595

(22) Filed: May 31, 2005

(51) Int. Cl. H04M 3/42

(52) U.S. Cl. 379/210.02

(57) ABSTRACT

A method and apparatus for providing control and monitoring of a group of plain old telephone service (POTS) stations from one control station. Incoming calls to the POTS stations are intercepted and the data describing the call is sent to the control station. The control station then provides directions for blocking the call, completing the call to the original POTS destination, or completing the call to another POTS destination. Outgoing calls are also monitored so that the control station maintains an up to date record of which stations are busy and which stations are idle. Advantageously, the control station communicates with the switch serving these POTS stations by analog signals (FSK) and/or DTMF thus overcoming the limitations on distance requirements for digital signaling.

### TECHNICAL FIELD

This invention relates to arrangements for controlling telecommunications calls from customer premises equipment.

### BACKGROUND OF THE INVENTION

In the telecommunications field, there are many arrangements available for directing calls to an appropriate destination within a group of associated destinations. In most cases, a computer is used to direct incoming calls, received with an identity of a caller, to the most appropriate destination. One such system is described in Gechter et al.: U.S. Pat. No. 5,036,535, issued Jul. 30, 1991.

A problem with such systems is their high expense. In many cases, a digital connection is required between the system and a serving central office switch; this limits the distance between the system and a serving central office.

### SUMMARY OF THE INVENTION

The above problem is alleviated in accordance with this invention wherein the customer premises equipment comprises a single data line for transmitting either analog data or voice and one or more conventional (Plain Old Telephone Services (POTS)) lines. Calls may be received in either the data/voice station or one of the POTS stations depending on the number called by the caller. If the call is for the number associated with one of the POTS stations, the call is not completed until a query has been made by the serving switch to the control station and the data station has generated a response for completing the call to the initial station, completing the call to another telephone number, or rejecting the call. The service is used in conjunction with incoming caller line identification so that the data station can use the identity of the caller to decide whether to accept the call at the dialed station, redirect the call to another station, or reject the call. Advantageously, only the control station connected to the data line needs to have an intelligent station. Advantageously, inexpensive voice band analog signaling arrangements can be used between the control station and the switch, e.g., dual tone multifrequency (DTMF) or frequency shift keying (FSK).

In accordance with one preferred embodiment, the data line and therefore the control intelligent station is informed whenever one of the other stations makes a call. For outgoing calls the intelligent station can block the calls, redirect the outgoing call to another telephone number, disconnect a call if a time threshold is exceeded, and, if desired, notify the caller. On these outgoing calls and incoming calls, the station associated with the data line can accumulate usage statistics and statistics concerning calling and called numbers for each of the POTS stations. Advantageously, this arrangement allows for monitoring and control of the POTS lines at very low cost.

In one embodiment, responsive to receipt of a call for the control station connected to the data line, the call can be redirected to one of the other stations. For such calls, the control station can request that the switch apply a distinctive ring. The call to the control station can also be automatically forwarded to another station if the call is not answered before the lapse of a predetermined interval. The control station's telephone number is, preferably, unpublished.

In accordance with one preferred embodiment of Applicants' invention, each of the POTS lines has a pointer to the data line and the data line has a linked list of the POTS lines which it controls. The data station keeps track of which POTS stations are connected to which telephone numbers both in order to maintain traffic statistics and in order to route incoming calls to an alternate station.

### BRIEF DESCRIPTION OF THE DRAWINGS

FIG. 1 is a block diagram illustrating the operation of Applicants' invention;

FIG. 2 is a flow diagram illustrating the process of handling an outgoing call from one of the POTS stations;

FIG. 3 is a flow diagram illustrating the process of handling an incoming call to one of the POTS lines; and

FIG. 4 is a flow diagram illustrating the process of handling an incoming call for the number of the data line.

### DETAILED DESCRIPTION

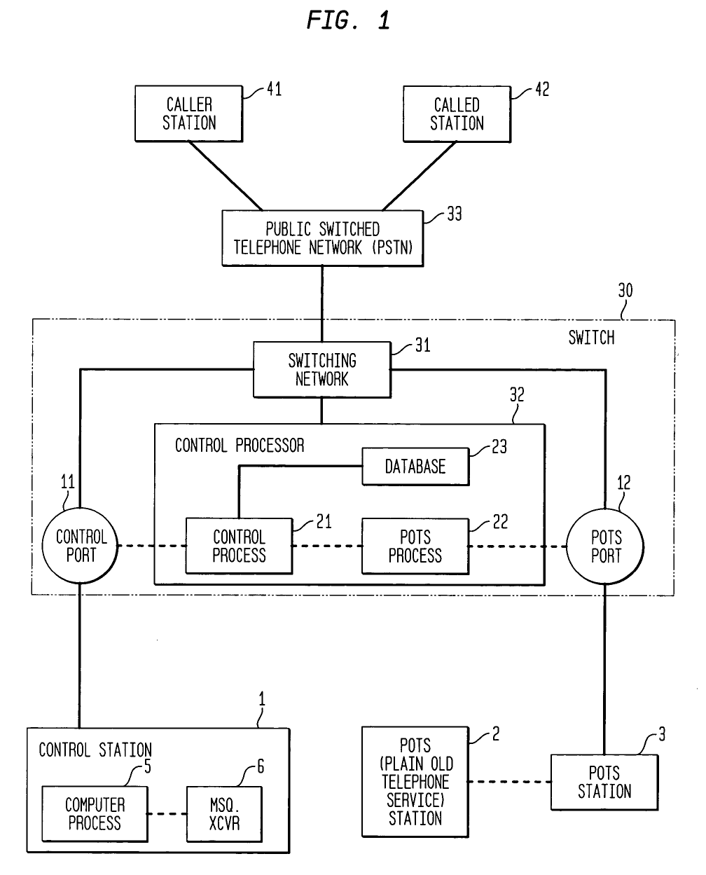

FIG. 1 is a block diagram illustrating the operation of Applicants' invention. A control station 1 comprises means for transmitting and receiving data messages 6 and a computer 5, such as a personal computer (PC), for interpreting incoming messages and generating outgoing messages. One or more POTS can exist, limited only by the messaging bandwidth of the control station. In FIG. 1, two POTS stations (2 and 3) are shown. The control station and the POTS stations are connected to a switch 30. The control station is connected to a control port 11 and POTS station 2 is connected to POTS port 12. The switch includes a switching network 31 and a control processor system 32. The control processor system controls processes 21 and 22 which are associated with control ports 11 and 12, respectively. The switching network 31 is also connected to the public switched telephone network 33 which is connected to caller station 41 and called station 42.

The control station uses voice band analog signaling (frequency shift keying (FSK) or dual tone multifrequency (DTMF)) to communicate with switch 30.

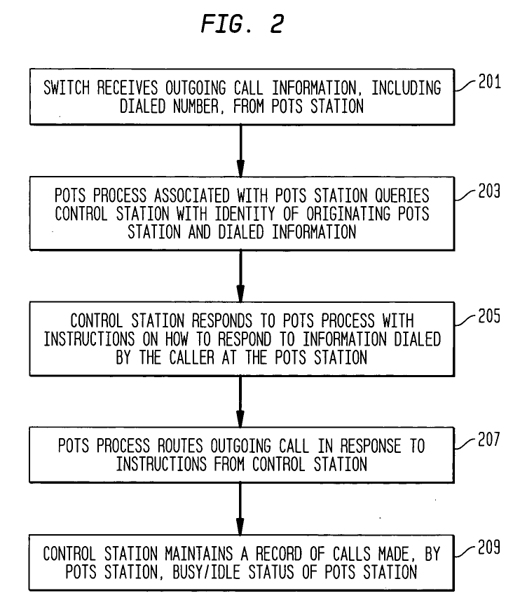

FIG. 2 is a flow diagram illustrating the processing of an outgoing call from one of the POTS stations. The POTS station 2 sends dialing information to POTS port 12 (action block 201). POTS port 12 is associated with an enhanced POTS process 22, which process sends a query message via control process 21 and control port 11 to control station 1 (action block 203). The query includes the identity of POTS station 2 and the dialed information. Control station 1 examines the contents of the query and generates a response message which is transmitted via control port 11 and control process 21 to POTS process 22 (action block 205). POTS process 22 examines the contents of the response message and performs one of a number of actions such as:

1. completing the call as dialed from POTS port 12 to a called station 42;

2. reroute the call to an alternative number;

3. block further action on the call (action block 207).

If the call is completed, then POTS process 22 notifies control station 1 of the completion of the call of the time that the called station answers and of the disconnect time of the call. This information is used by control station 1 to route calls only to an available POTS station and to accumulate statistics about call usage by POTS station 2 (action block 209). If POTS station 2 is allowed to complete the call but is not allowed to call the called station for more than a predetermined length of time, then the control station transmits messages to cause a tone to be applied to POTS station 2 some time, such as 15 seconds, before the limit is reached; if POTS station 2 has not yet disconnected when the time limit is reached, the control station sends another message to cause a disconnect when the maximum time is reached.

All control messages are sent by switch under a guard timer. If there is no reply (e.g., control station down) then the switch proceeds to complete the call in a default manner by ringing the dialed number if idle.

For reliability, the switch periodically sends a timed busy/idle status refresh of all POTS stations to the control station in the event the control station was offline for some time (e.g., computer malfunction). Control station could also request this by dialing a special reserved control DN on the switch.

For calls with no caller identification or suppressed caller identification, special treatment such as an announcement can be provided.

The call treatment can be made a function of the time of day and/or day of the week, so that, for example, calls outside business hours can be routed to voice mail.

For calls to a busy POTS station which has call waiting service, a distinct call waiting tone can be provided under the control of the control station. Alternatively or in addition, all calls to the busy station except priority calls can be sent to busy tone.

For calls for which no further control messages are received by the switch, the switch can itself provide default treatment such as routing to voice mail after a timeout in ringing.

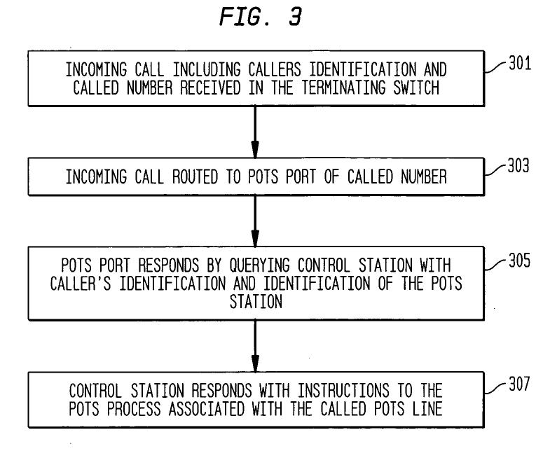

FIG. 3 is a flow diagram illustrating the processing of an incoming call to a POTS line. A call, including an incoming caller line identifier, is accepted in switch 30 (action block 301) and if the called station 2 is idle, a process 22 is created (action block 303). A query is sent (action block 305) from POTS process 22 to control process 21 to control port 11 and thence to control station 1. The control station responds with a message which is sent via control port 11 and control process 21 to the POTS process 22 (action block 307). The message calls for one of a number of actions:

1. attempt to complete as dialed by attempting to complete the call from POTS port 12 to POTS station 2;

2. redirect the call to an alternative station identified by an alternative telephone number; or

3. block the call and send busy tone or an announcement to the caller.

The attempted call completion may be done with distinctive ringing applied from the serving switch in response to a message from the control station. If the attempted call is not completed within x seconds, then another query is sent to the control station 1, which may provide a new call routing, may simply allow the call not to be completed, or route the call to a voice mail number stored in the switch.

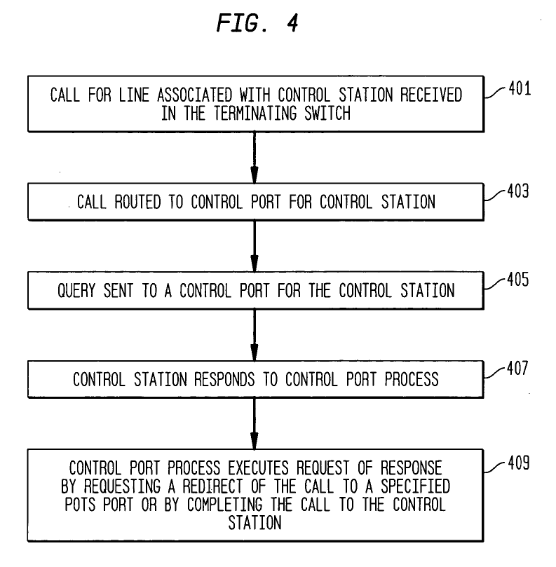

FIG. 4 is a flow diagram illustrating the processing of an incoming call to the control station. The call is received in the serving switch (action block 401) and switched through switching network 31 to control port 11 (action block 403) and a query is sent from control port 11 to control station 1 (action block 405). Based on the response to that query which is sent to the control port 11 (action block 407) and thence to the control process 21, the call may be redirected to one of the POTS phones or may simply be completed via the data line to control station 1 (action block 409).

The database 23 of the control processor system 32 contains the data which allows the control process 21 to identify the control port 12 and vice versa. The data for control port 11 includes a linked list of the identities of all the POTS ports associated with control port 11 and the data for POTS port 12 includes the identity of the control port 11. This allows the control process 22 to respond to an incoming call by identifying the control port 11 and its associated control process 21. If the control station wishes to reroute an incoming call to another POTS port, the identities of all the POTS ports are stored in a linked list in the database 23.

An arrangement wherein one control station serves a single POTS station is desirable when the control station is used primarily for computer access (e.g., ISP). If V.92 is used between the computer and ISP, the busy call can be given call waiting treatment; the control station can then send a brief set of call completion instructions. This can be useful at night to screen all but a selected group of priority business callers, while sending other callers to voice mail. It can also be useful for applying distinctive ringing signals, selected by the control station, to alert a user of the POTS station as to the type of caller.

The control station 1 can update the database 23, for example, to change routing among the POTS stations. For example, if POTS station 3 is not to receive any calls not dialed directly to the number of that POTS station, the database 23 can be modified by a message from control station 1 to eliminate alternate routing to that station. This would be done in response to an FSK or DTMF message sent from control station 1 to switch 30.

The control station 1 can keep call logs for all of the POTS stations and for itself. This allows system administrators to monitor the performance of agents staffing the individual POTS lines.

When the control station sends an incoming call to a voice messaging system (not shown), it can send a request to the control processor system 32 to send a message to the appropriate POTS station to turn on a message waiting lamp.

The above description is of one preferred embodiment of Applicants' invention. Other embodiments will be apparent to those of ordinary skill in the art without departing from the scope of the invention. The invention is limited only by the attached claims.

We claim:

1. A method of completing an incoming call to one of a plurality of plain old telephone service (POTS) stations, all of said POTS stations associated with a single control station, comprising the steps of:
receiving said incoming call in a port of a POTS station identified by a called telephone number;
responsive to receipt of said call, said call including an identification of a caller of said call, sending a query message to said control station;
said control station sending a response message to a process associated with said POTS station for further processing said call.

2. The method of claim 1 further comprising the step of:
completing said call to said POTS station.

3. The method of claim 1 further comprising the step of:
completing said call to another of said plurality of POTS stations.

4. The method of claim 1 further comprising the step of:
forwarding said call to a station on another switch.

5. The method of claim 1 further comprising the steps of:
maintaining a record of a busy-idle status for all of the POTS stations; and
diverting a call from a POTS station busy on an outgoing call to another of said plurality of POTS stations or to a voice messaging system.

6. The method of claim 1 further comprising the steps of:
completing a call to said control station; and
providing for control messages between the switch and the control station for calls to and from other POTS stations while keeping a connection for the call to said control station.

7. The method of claim 1 further comprising the step of:
sending a message from said control station to request application of a distinctive ringing signal to the switch; and
applying the distinctive ringing signal to a call to one of said POTS stations.

8. The method of claim 1 further comprising the step of:
providing pre-programmed processing of calls with no caller identification.

9. The method of claim 1 further comprising the step of:
sending a message to request application of a distinctive call waiting tone from said control station to a serving switch; and
applying the distinctive call waiting tone to a call to one of said POTS stations.

10. The method of claim 1 wherein default call processing features are provided directly from a serving switch when said control station does not send a response message for further processing said call.

11. The method of claim 1 further comprising the steps of:
storing a database for controlling routing for calls to said control station and said plurality of POTS stations in a serving switch; and
modifying contents of said database in response to a message from said control station.

12. The method of claim 1 further comprising the step of:
said control station maintaining a log of calls for each of said plurality of POTS lines.

13. The method of claim 1 further comprising the steps of:
said control station sending an incoming call to a voice messaging system; and
said control station sending a request to turn on a message waiting lamp on one of said plurality of POTS stations.

14. Apparatus for completing an incoming call to one of a plurality of plain old telephone service (POTS) stations, all of said POTS stations associated with a single control station, comprising:
means for receiving said incoming call in a port of a POTS station identified by a called telephone number, said port being connected to a serving switch;
means, responsive to receipt of said call, said call including an identification of a caller of said call, for sending a query message to said control station;
said control station comprising means for sending a response message to a process of said serving switch associated with said POTS station for further processing said call.

15. The apparatus of claim 14 further comprising:
means, responsive to receipt of said response message, for completing said call to said POTS station.

16. The apparatus of claim 14 further comprising:
means, responsive to receipt of said response message, for completing said call to another of said plurality of POTS stations.

17. The apparatus of claim 14 further comprising:
means, responsive to receipt of said response message, for forwarding said call to a station on another switch.

18. The apparatus of claim 14 further comprising means for providing pre-programmed processing of calls with no caller identification.

19. The apparatus of claim 14 wherein said serving switch provides means for performing default call processing features if no response message is received from said control station.

20. The apparatus of claim 14 wherein said message to said control station is sent as a voice band analog signal.
